(19) United States
(12) Patent Application Publication
(10) Pub. No.: US 2020/0245025 A1
(43) Pub. Date: Jul. 30, 2020

(54) ELECTRONIC PROGRAM LISTING DISPLAYING PROGRAMMING AVAILABLE IN DIFFERENCT RESOLUTIONS

(71) Applicant: THOMSON LICENSING, Issy-les-Moulineaux (FR)

(72) Inventors: Joel M. FOGELSON, Pasadena, CA (US); Arden A. ASH, Los Angeles, CA (US); Krystle SWAVING, LOS ANGELES, CA (US); Guillaume Andre Roger GOUSSARD, Los Angeles, CA (US)

(21) Appl. No.: 15/763,115

(22) PCT Filed: Sep. 29, 2015
(86) PCT No.: PCT/US2015/052890

§ 371 Date: Mar. 25, 2018

(51) Int. Cl. H04N 21/4402; H04N 21/485; H04N 21/482

(52) U.S. Cl. CPC H04N 21/44029; H04N 21/4821; H04N 21/4858; H04N 21/4854

(57) ABSTRACT

The present principles generally relate to methods, systems and apparatus for electronic program listing processing and/or display. In particular, the present principles relate to providing (330) an electronic program listing (400; 500) or the like which is capable of indicating to viewers programs with different resolutions of content by using different resolutions, or degrees of sharpness or blurriness of graphical representations (401, 402, 403, 404, 405, 406, 407, 408, 409; 510, 520, 530, 540) corresponding to the plurality of programs on the electronic program listing (400; 500). This way, a viewer is able to recognize easily and quickly which of the programs are, e.g., ultra high definition (UHD), high definition (HD), or standard definition (SD), just by glancing at the electronic program listing (400; 500).

### TECHNICAL FIELD

The present principles generally relate to methods, systems and apparatus for electronic program listing processing and/or display. In particular, the present principles relate to providing an electronic program listing or the like which is capable of indicating to viewers programs with different resolutions of content by using different resolutions, or degrees of sharpness or blurriness of graphical representations corresponding to the plurality of programs on the electronic program listing. This way, a viewer is able to recognize easily and quickly which of the programs are, e.g., ultra high definition, high definition, or standard definition, just by glancing at the electronic program listing.

### BACKGROUND

Content of a digital television program may be formatted in a wide variety of formats. As is well known in the art, standard definition (SD) digital TV typically refers to the digital TV formats of 480i (480 lines of resolutions scanned in interlaced or alternate fields, with a frame size of 720×480 pixels) or 480p (480 lines of resolutions scanned progressively, with a frame size of 720×480 pixels). Also as well known in the art, high definition (HD) television typically refers to one of the three formats: 720p (720 lines of resolutions scanned progressively, with a frame size of 1280×720 pixels), 1080i (1080 lines of resolutions scanned in interlaced or alternate fields, with a frame size of 1920×1080 pixels), and 1080p (1080 lines of resolutions scanned progressively, with a frame size of 1920×1080 pixels).

Recently, ultra high definition (UHD) television formats have also been proposed and used. These formats include 4K UHD format of 2160p (2160 lines of resolutions scanned progressively, with a frame size of 3840×2160 pixels), which is four times as many pixels as the HD formats of 1080i or 1080p of 1920×1080 (2.07 megapixels). Another UHD format is the 8K UHD format of 4320p which is 7680 pixels wide by 4320 pixels tall and has 4320 horizontal lines scanned progressively.

Furthermore, electronic devices such as televisions, set top boxes, personal computers (PC), tablets, cellphones, and etc., require a control system that includes a user interface system. Typically, a user interface system provides information to and receives information from a user, and enables the usage of the device. One example of a user interface system is an electronic program listing and its associated user interaction menu in an electronic device.

An electronic program listing may comprise a program or media asset information listing, related information database, and/or an interactive user interface. An electronic program listing obtains metadata including program information about program contents from an information provider (which may differ from the program content provider) and may display the program information to a user. As used herewith, metadata are defined as data that describe other data, as is well known in the art. In the example of an electronic program listing, metadata are data which describe, for example, program content. The program content may be a video and/or an audio media asset from various sources, such as, for example, broadcast, satellite, internet, local storage media, and etc. Program listing metadata information typically comprises programming information for a program such as, for example, program format (such as e.g., high-definition or low definition), channel number, program title, start time, end time, elapsed time, time remaining, review rating, parental guide rating, genre, a description of the program's content, and, etc. Also, metadata may also include graphical representations comprising one or more or texts and/or images representing the plurality of the programs on the program listing. These graphical representations may be hypertext-linked, as is well known in the art.

For example, FIG. 1A shows a known program listing 100 which is used by a media content provider MGO on its website www.mgo.com. As shown in FIG. 1A, the electronic program listing 100 provides a list of visual representations of newly released media assets available to a user for viewing and/or downloading. The electronic program listing 100 displays a plurality of graphical representations representing the different programs selectable by the user. The graphical representations may comprise hypertext linked images and/or texts which will lead to other menu choices or device actions (e.g., playing of the video), if they are selected by the viewer.

FIG. 1B illustrates another exemplary electronic program listing in a representation of an electronic program guide (EPG) 105 in a grid format, as well known in the art. The “grid guide” 105 has a plurality of grids in the central portion of the guide 105. Each grid in the central portion of the EPG 105 may represent a selectable program. By looking at the horizontal and vertical axes of the program guide 105, a viewer may easily determine what time a particular program will be shown and on which channel. In addition, as illustrated in FIG. 1C, a viewer may highlight and select one of the grids in a grid program guide 110 for viewing or to obtain further information about the selected program. For example, FIG. 1C shows what happens when a viewer has highlighted and selected the movie ZULU 130 in order to obtain further information about the program. In response, EPG 110 in FIG. 1C displays additional program guide information for the movie ZULU as shown in information panel 135. The additional program guide information may include, e.g., detailed information about actors, producers, ratings, and etc., of the movie ZULU as shown in panel 135 of FIG. 1C.

Also, U.S. Pat. No. 6,111,611, issued to Ozkan et al., describes in detail an exemplary embodiment of a system for providing program listing metadata information to an electronic device including data packet structure for carrying the program listing information from a provider to the electronic device. The exemplary data packet structure is designed so that both the channel information (e.g., channel name, call letters, channel number, type, etc.) and the program description information (e.g., content format, title, rating, star, genre, etc.) relating to a program may be transmitted from a program listing database provider to a receiving and/or processing apparatus.

### BRIEF SUMMARY OF THE DRAWINGS

The features and advantages of the present principles may be apparent from the detailed description below when taken in conjunction with the figures described below:

FIGS. 1A-1C show examples of existing electronic program listings.

FIG. 2 shows an exemplary system including an exemplary apparatus according to the present principles.

FIG. 3 shows an exemplary process according to the present principles.

FIG. 4 shows an exemplary electronic program listing according to the present principles.

FIG. 5 shows another exemplary electronic program listing according to the present principles.

FIG. 6 shows examples of different formats of graphical representations according to the present principles.

FIG. 7 shows other examples of different formats of graphical representations according to the present principles.

### SUMMARY OF PRESENT PRINCIPLES

Accordingly, the present principles provide an apparatus, comprising: a communication interface configured to receive metadata associated with a program of video data, said metadata indicating a corresponding video resolution format of content of the program; and a processor configured to provide an electronic program listing to a video display, wherein the electronic program listing comprising a plurality of graphical representations representing different programs including the program of the video data, and a resolution of a graphical representation corresponding to the program of the video data is selected in response to the corresponding video resolution format of the content of the program indicated in the received metadata.

Accordingly, the present principles provide an apparatus, comprising: a communication interface configure to receive metadata associated with a program of video data, said metadata indicating a corresponding video resolution format of content of the program; and a processor configured to provide an electronic program listing to a video display, wherein the electronic program listing comprising a plurality of graphical representations representing different programs including the program of the video data, and a degree of sharpening of a graphical representation corresponding to the program of the video data is selected in response to the corresponding video resolution format of the content of the program indicated in the received metadata.

The present principles further provide a method comprising: receiving, via a communication interface, metadata associated with a program of video data, said metadata indicating a corresponding video resolution format of content of the program; and providing an electronic program listing to a video display, wherein the electronic program listing comprising a plurality of graphical representations representing different programs including the program of the video data, and a resolution of a graphical representation corresponding to the program of the video data is selected in response to the corresponding video resolution format of the content of the program indicated in the received metadata.

The present principles further provide a method comprising: receiving, via a communication interface, metadata associated with a program of video data, said metadata indicating a corresponding video resolution format of content of the program; and providing an electronic program listing to a video display, wherein the electronic program listing comprising a plurality of graphical representations representing different programs including the program of the video data, and a degree of sharpening of a graphical representation corresponding to the program of the video data is selected in response to the corresponding video resolution format of the content of the program indicated in the received metadata.

The present principles further provide a computer program product stored in non-transitory computer-readable storage media comprising computer-executable instructions for: receiving metadata associated with a program of video data, said metadata indicating a corresponding video resolution format of content of the program; and providing an electronic program listing to a video display, wherein the electronic program listing comprising a plurality of graphical representations representing different programs including the program of the video data, and a resolution of a graphical representation corresponding to the program of the video data is selected in response to the corresponding video resolution format of the content of the program indicated in the received metadata.

### DETAILED DESCRIPTION

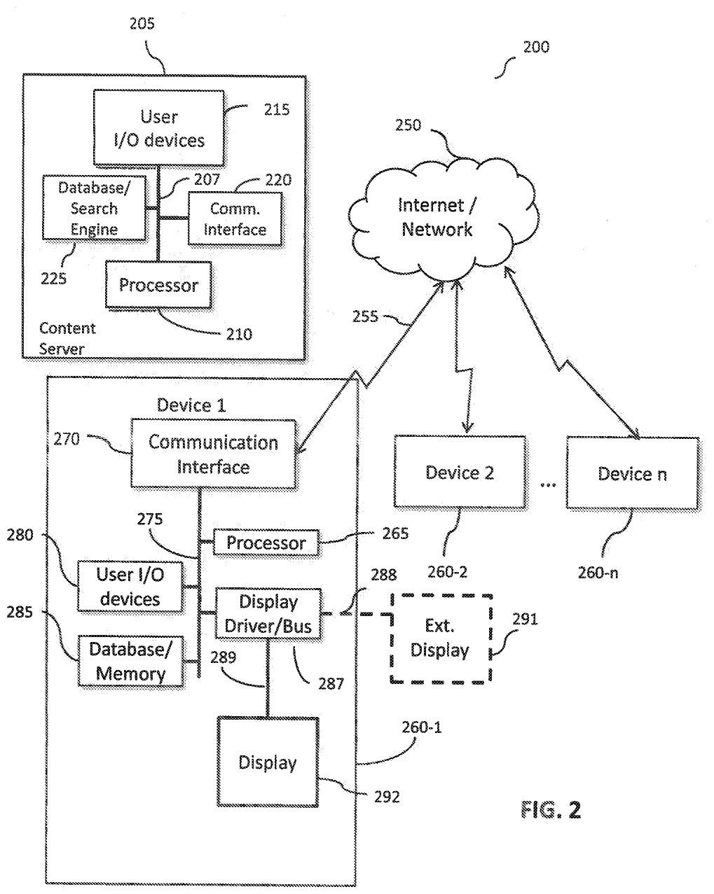

FIGS. 2-7 illustrate various exemplary embodiments according to the present principles. The functions of the various elements shown in the figures may be provided through the use of dedicated hardware as well as hardware capable of executing software in association with appropriate software. When provided by a processor, the functions described herewith may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include implementations such as, without limitation, digital signal processor (“DSP”) hardware, Programmable Logic Array (PLA), Application Specific Integrated Circuit (ASIC), read-only memory (“ROM”) for storing software, random access memory (“RAM”), non-volatile storage, or the like.

Also, although each of the components in the drawings is shown as an individual block, each individual block may further represent, e.g., one or more combinations of circuitries such as, e.g., one or more integrated circuits (ICs), one or more circuit boards, or one integrated circuit (IC) with one or more circuitries embedded on the same IC die, as well known in the art. For example, a communication interface block 207 shown in FIG. 2 may represent one or more integrated circuits or circuit boards having a combination of different communication capabilities such as, e.g., Ethernet, Wi-Fi, cellphone, cable, satellite, and/or terrestrial TV communication, etc., as to be described in more detail below.

As used herewith, an ultra high definition (UHD) format refers to a video resolution of at least 3840×2160 pixels per frame (i.e., 2160p format). Also, as used herewith, high definition (high definition) format refers to a resolution of between 1280×720 pixels per frame (i.e., 720p format) and 1920×1080 pixels per frame (i.e., 1080i or 1080p format), inclusively. Finally, as used herewith, standard definition refers to any resolution less than 1280×720 pixels per frame (i.e., 720p format). In one exemplary embodiment, an apparatus and method according to the present principles simply reacts to an indication in metadata of the resolution format of the corresponding program without regard to the actual resolution of the content of the program being received, since the actual content is typically received later.

The present invention recognizes that not all of the program contents may be encoded and transmitted in same resolution format due to a variety of factors, such as cost, transmission bandwidth, original content format, and etc. Therefore, it is desirable to be able to provide apparatus and methods for viewers to recognize easily which programs are available in what resolutions, by simply looking at an electronic program listing.

FIG. 2 shows an exemplary system according to the present principles. For example, a system 200 in FIG. 2 includes a content server 205 which is capable of receiving and processing user requests from one or more of user devices 260-1 to 260-n. The content server 205, in response, provides programs comprising various media assets such as movies or TV shows for transporting, viewing, streaming or downloading.

In particular, various user devices 260-1 to 260-n in FIG. 2 may communicate with the exemplary server 205 over a communication network 250 such as the internet, a wide area network (WAN), and/or a local area network (LAN). Server 205 may communicate with user devices 260-1 to 260-n in order to provide relevant information such as metadata, web pages, media contents, and etc., to user devices 260-1 to 260-n. Server 205 may also provide additional processing of information when the processing is not available and/or capable of being conducted on the local user devices 260-1 to 260-n. As an example, server 205 may be a computer having a processor 210 such as, e.g., an Intel processor, running an appropriate operating system such as, e.g., Windows 2008 R2, Windows Server 2012 R2, Linux operating system, and etc. In addition, processor 210 controls the various functions and components of the server 205 via a control bus 207 as shown in FIG. 2.

User devices 260-1 to 260-n may access different media assets, web pages, services or databases provided by server 205 using, e.g., HTTP protocol. A well-known web server software application which may be run by server 205 to provide web pages is Apache HTTP Server software available from http://www.apache.org.

Likewise, examples of well-known media server software applications include Adobe Media Server and Apple HTTP Live Streaming (HLS) Server. Using media server software as mentioned above and/or other open or proprietary server software, server 205 may provide media content services similar to, e.g., Amazon.com, Netflix, or M-GO. Server 205 may use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various programs comprising various media assets such as, e.g., video programs, audio programs, movies, TV shows, software, games, electronic books, electronic magazines, electronic articles, and etc., to an end-user device 260-1 for purchase and/or viewing via streaming, downloading, receiving or the like.

In addition, a server administrator may interact with and configure server 205 to run different applications using user input/output (I/O) devices 215 (e.g., a keyboard and/or a display) as well known in the art. Furthermore, various web pages, data, media assets and their associated metadata may be stored in a database 225 and accessed by processor 210 as needed. Database 225 may reside in appropriate non-transitory storage media, such as, e.g., one or more hard drives and/or other suitable memory devices, as well known in the art. Similarly, computer program products for the server 205 may also be stored in such non-transitory storage media. Also, element 225 of server 205 may also represent a search engine so that media recommendations may be made, e.g., in response to a user's profile of consumption and/or purchases of media assets, and/or criteria that a user specifies using textual input (e.g., entering “sports”, “adventure”, “Tom Cruise”, and etc.).

In addition, server 205 is connected to network 250 through a communication interface 220 for communicating with other servers or web sites (not shown) and to one or more user devices 260-1 to 260-n, as shown in FIG. 2. The communication interface 220 may also represent television signal modulator and RF transmitter in the case of when the content provider 205 represents a television station, cable or satellite television provider. In addition, one skilled in the art would readily appreciate that other server components, such as, e.g., ROM, RAM, power supply, cooling fans, etc., may also be needed, but are not shown in FIG. 2 to simplify the drawing.

User devices 260-1 to 260-n shown in FIG. 2 may be one or more of, e.g., a PC, a laptop, a tablet, a cellphone, a video receiver, and etc. One of such devices may be, e.g., a Microsoft Windows 10 computer/tablet, an Android phone/tablet, an Apple IOS phone/tablet, or a television receiver or the like. A detailed block diagram of an exemplary user device according to the present principles is illustrated in block 260-1 of FIG. 2 as Device 1.

An exemplary user device 260-1 in FIG. 2 comprises a processor 265 for processing various data and for controlling various functions and components of the device 260-1, including video decoding and processing to play and display a received program content. The processor 265 communicates with and controls the various functions and components of the device 260-1 via a control bus 275 as shown in FIG. 2.

In additional, device 260-1 also comprises user input/output (I/O) devices 280 which may comprise, e.g., a touch and/or a physical keyboard for inputting user data, and/or a speaker, and/or indicator lights, for outputting visual and/or audio user data and feedback. Device 260-1 also comprises a memory 285 which may represent both a transitory memory such as RAM, and a non-transitory memory such as a ROM, a hard drive or a flash memory, for processing and storing different files and information as necessary, including computer program products, webpages, user interface information, metadata including electronic program listing information and database and etc., as needed. Device 260-1 also comprises a communication interface 270 for connecting and communicating to/from server 205 and/or other devices, via, e.g., network 250 using e.g., a connection through a cable network, a FIOS network, a Wi-Fi network, and/or a cellphone network (e.g., 3G, 4G, LTE), and etc.

Device 260-1 may also comprise a display 292 which is driven by a display driver/bus component 287 under the control of processor 265 via a display bus 289 as shown in FIG. 2. In one exemplary embodiment, the display 292 is capable of displaying content in SD, HD or UHD format. The type of the display 292 may be, e.g., LCD (Liquid Crystal Display), LED (Light Emitting Diode), OLED (Organic Light Emitting Diode), and etc., as well known in the art. In addition, an exemplary user device 260-1 according to the present principles may have its display outside of the user device, or that an additional or a different external display may be used to display the content provided by the display driver/bus component 287. This is illustrated, e.g., by an external display 291 which is connected to an external display bus 288 of device 260-1 of FIG. 2.

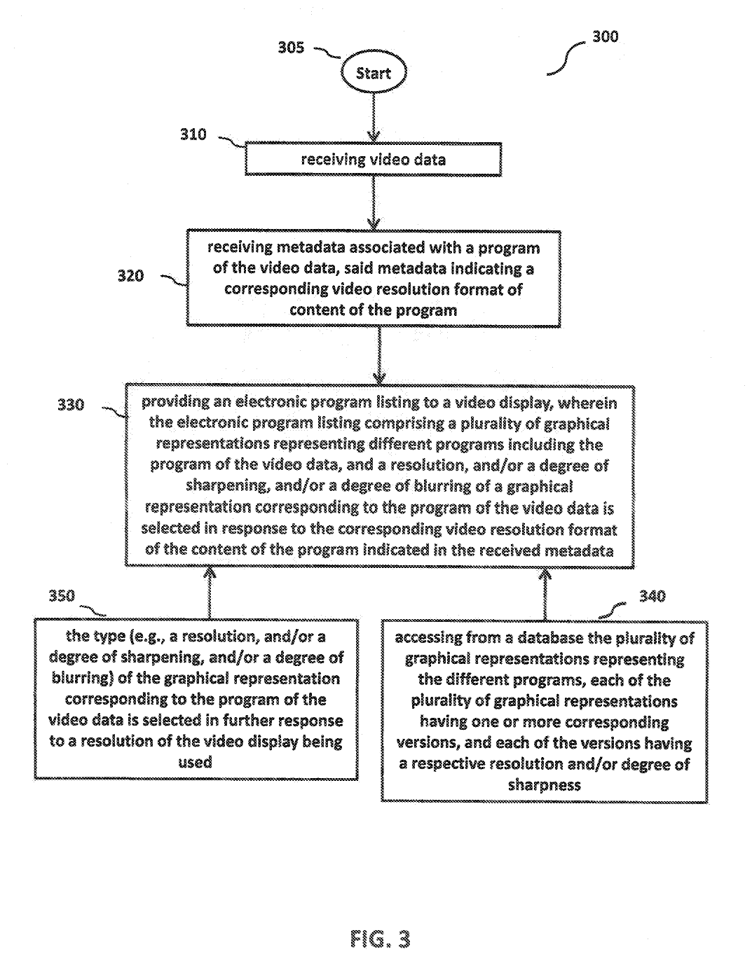

FIG. 3 represents a flow diagram of an exemplary process 300 according to the present principles. Process 300 may be implemented as a computer program product comprising computer executable instructions which may be executed by e.g., processor 265 of device 260-1 of FIG. 2. The computer program product having the computer-executable instructions may be stored in a non-transitory computer-readable storage media as represented by e.g., memory 285 of FIG. 2. One skilled in the art can readily recognize that the exemplary process shown in FIG. 3 may also be implemented using a combination of hardware and software (e.g., a firmware implementation), and/or executed using PLA or ASIC, etc., as already mentioned above.

At 310 of FIG. 3, video data are received via, e.g., a communication interface 270 of an electronic device 260-1 of FIG. 2. At 320 of FIG. 3, metadata associated with a program of the video data are also received by, e.g., electronic device 260-1 of FIG. 2. The metadata may also be received through the same or different communication interface as that of the video data. The metadata may come from the same source as the provider of the video data or through another source. That is, for example, the video source may be provided via the content server 205 of FIG. 2, but the metadata associated with the video data may be provided, e.g., by another website, server, television provider, and/or through a different network and/or transmission medium. Metadata, according to the present principles, indicate a corresponding video resolution format of the content of the program in the video data. That is, the metadata would indicate whether the corresponding video resolution format is one of: 1) standard definition, 2) high definition, and 3) ultra high definition.

At 330 of FIG. 3, an electronic listing according to the present principles is provided to a display device, such as e.g., display 291 and/or display 292 in FIG. 2. The electronic program listing comprises a plurality of graphical representations representing different programs including the program of the video data. In addition, a resolution, a degree of sharpening, and/or a degree of blurring of a graphical representation corresponding to the program of the video data is selected in response to the corresponding video resolution format of the content of the program indicated in the received metadata.

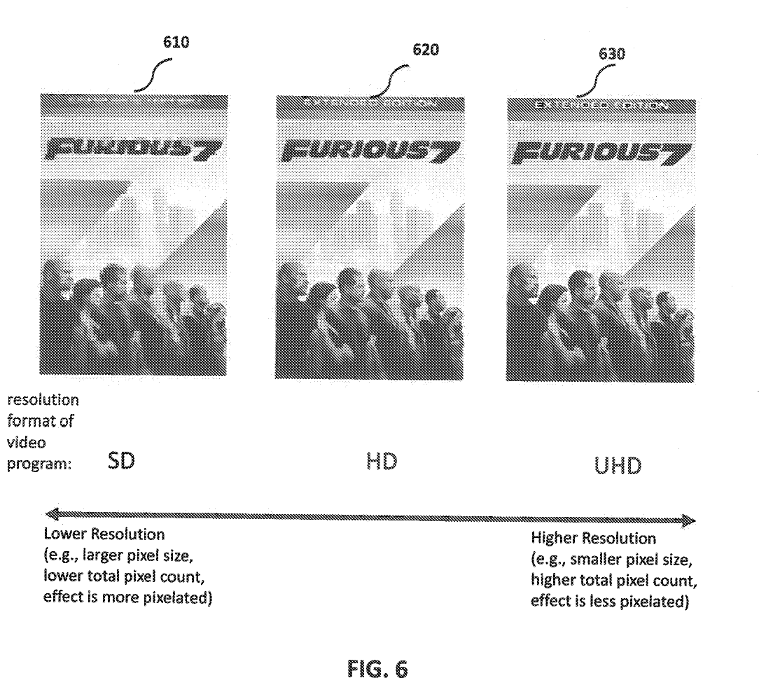

According to the present principles, FIG. 6 shows how a graphical representation of a movie “Furious7’ may be selected and presented in a program listing and provided to a display device. As shown in FIG. 6, the resolution of the graphical representation corresponding to the program is selected such that a higher resolution of the graphical representation is selected in correlation with the corresponding video resolution format of the content of the program indicated in the received metadata as being higher. For example, if the metadata indicate that the program format is in, e.g., SD format (i.e., a lower video resolution format than the other video formats), then a graphical representation 610 which has a correspondingly lower resolution image compared with the resolutions of either the graphical representations 620 and 630 in FIG. 6 will be selected for use in the program listing. The lower resolution graphical representation 610 comprises of, e.g., a larger pixel size or a lower total pixel count as shown in FIG. 6.

On the other hand, if the metadata indicate that the program format to be received is, e.g., UHD (i.e., a higher video resolution format than the others), then a graphical representation 630 which has a correspondingly higher resolution comprising of e.g., a smaller pixel size or a higher total pixel count will be selected for use, as shown in FIG. 6. Likewise, if the metadata indicate that the video format of the program is HD, a graphical representation 620 with a resolution in between the graphical resolutions of 610 and 630 of FIG. 6 will be used and presented for the movie “Furious7.” Therefore, according to the present principles, the resolutions of the graphical presentations are chosen in response to the video resolutions indicated in the metadata so that a viewer is able to recognize easily and quickly which programs are in what video formats, just by glancing at an electronic program listing.

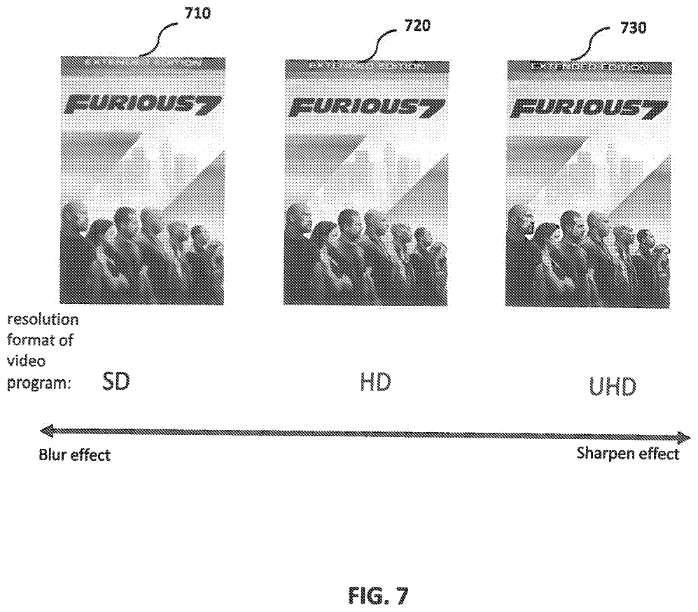

In another exemplary embodiment according to the present principles, instead of varying the resolution of a graphical representation of a program as illustrated in FIG. 6, different digital image processing of the graphical representation may be used. For example, FIG. 7 shows that a graphical representation of the “Furious7” may be sharpened or blurred to represent different video resolutions of programs, with a higher degree of sharpness representing a higher video resolution of the corresponding program, or a higher degree of blurriness representing a lower video resolution. One skilled in the art may readily appreciate that may photo or image processing software are available to provide digital image processing and filtering functions such as sharpening or blurring of a graphical representation.

For example, www.GIMP.org provides a freely distributed GNU Image Manipulation Program (GIMP). This software is capable of performing tasks such as image and photo retouching, image composition and image authoring including sharpening and/or blurring of images. In particular, the software provides an exemplary simple Sharpen filter which accentuates edges but also any noise or blemish, as well as an exemplary Unsharp Mask sharpening filter which sharpens edges of the elements without increasing noise or blemish. Both of these sharpness filters may be used according to the present principles to provide different degree of sharpness corresponding to the different graphical representation as shown in FIG. 7.

In addition, GIMP software also provides a plurality of different blurring filters. For example, an exemplary Simple Blur filter is included which produces an effect similar to that of an out-of-focus camera shot. To produce this blur effect, the filter takes the average of the present pixel value and the value of adjacent pixels and sets the present pixel to that average value. The GIMP software also provides an exemplary Gaussian Blur filter which is a broadly used blur filter. It has an efficient implementation that allows it to create a more blurred image in a relatively short time.

Accordingly, for example, a graphical representation 720 representing the movie “Furious7” may be sharpened by one of the exemplary sharpness filters described above to obtain another graphical representation 730 which has a higher degree of sharpness in order to represent another program having a higher video resolution. As an alternative, the same graphical representation 720 may be blurred by one of the exemplary blurriness filters described above to obtain another graphical representation 710 having a higher degree of blurriness to represent another program having a video content which has a lower resolution than that of either a HD or UHD program.

Another exemplary blurriness filters provided by the GIMP software is a pixilation Pixelize filter which produces the well-known “Abraham Lincoln” effect by turning the image into a set of large square pixels. The effect of this filter is illustrated in FIG. 6 since this filter has the same effect as that of increasing the pixel size and reducing the total pixel count as shown by element 610 of FIG. 6.

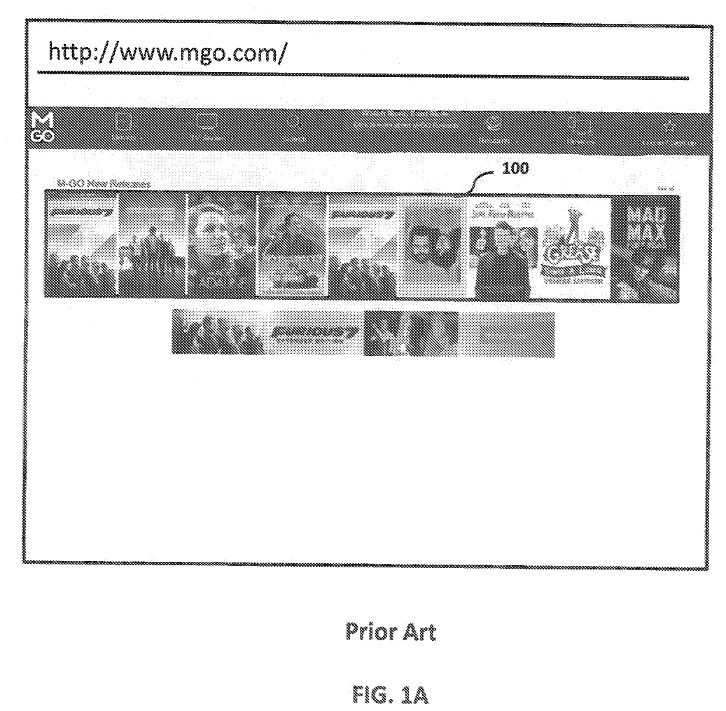

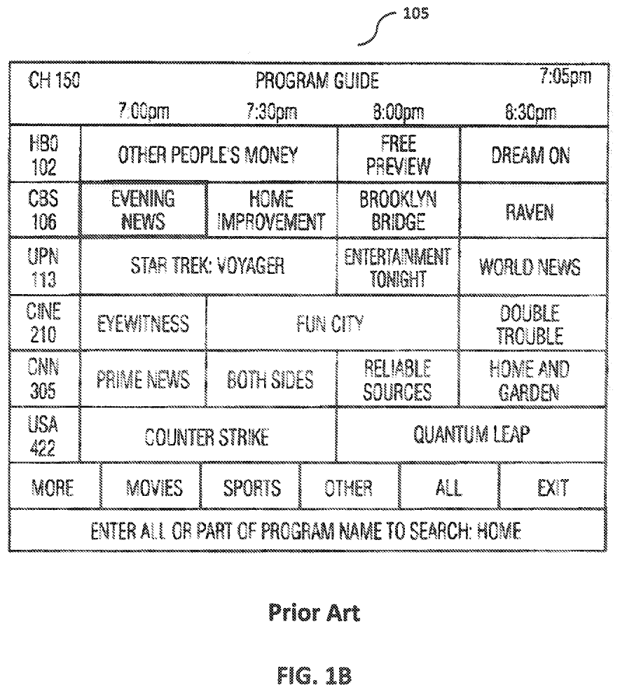

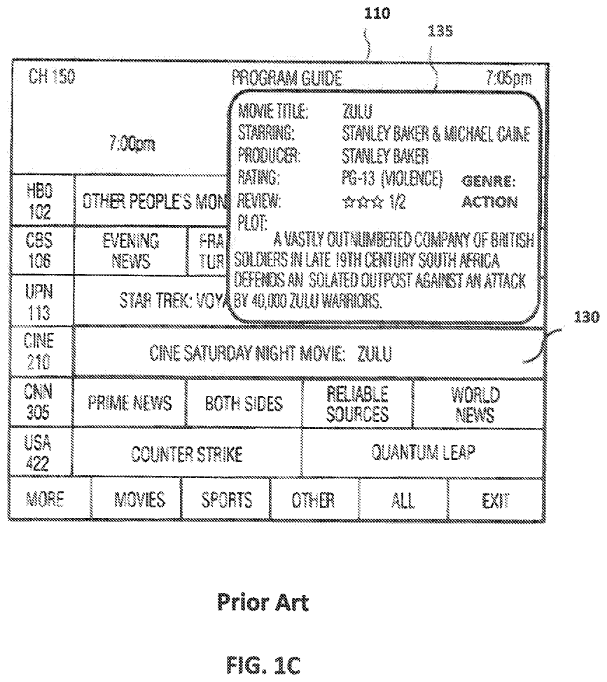

At 340, according to the present principles, a database may be provided which store the plurality of graphical representations representing the different programs. In one exemplary embodiment, each of the plurality of graphical representations representing a program such as “Furious7” may have one or more corresponding versions, and each of the versions having a respective image resolution. That is, for example, in one implementation, three different graphical representations of 610, 620 and 630 of FIG. 6, or 710, 720 and 730 of FIG. 7 may be stored in and accessed from a database to represent respectively the three different video resolution formats of SD, HD and UHD of the same movie “Furious7.” In one exemplary embodiment, these graphical images may be stored in database 225 or the content server 205 in FIG. 2 and provided as part of metadata to an exemplary device 260-1 of FIG. 1, and/or stored in a database 285 of device 261-1 of FIG. 1. In another exemplary embodiment as already described above, only one graphical representation is provided for each program title. The other versions of the graphical representations of the same program title may be obtained using one of an exemplary sharpness or blurriness filters as described above.

Therefore, according to the present principles, as shown in FIGS. 6 and 7, the graphical representation corresponding to the program of the video data uses: 1) a first pixel size for the metadata indicating that the corresponding video resolution format of the content of the program is a standard definition format, 2) a second pixel size for the metadata indicating that the corresponding video resolution format of the content of the program is a high definition format, or 3) a third pixel size for the metadata indicating that the corresponding video resolution format of the content of the program is an ultra high definition format.

At 350, the type (e.g., a resolution, and/or a degree of sharpness, and/or a degree of blurriness) of the graphical representation corresponding to the program of the video data is selected in further response to a resolution of the video display being used. For example, if the display being used is an Ultra High HD (UDH) resolution display, all three types of graphical representations 610, 620 and 630 having varying number of pixels may be used to represent programs in SD, HD and UHD format respectively. However, in one exemplary embodiment, if the display being used is only a SD capable display, then only the low resolution image 610 is used even if the metadata indicate that the same movie in HD or UHD format may be available, since the display is not capable of displaying the higher resolution content anyway. In an alternative embodiment, even if the display is only capable of displaying SD program, a sharpness or a blurriness filter, and/or a sharpened or a blurred image may be used to still inform the viewer that a different resolution format of the same programs is available, even though the viewer cannot view the higher resolution content on his or her SD display. This may encourage the viewer to upgrade to a more capable device or display in order to be able to watch the higher resolution content.

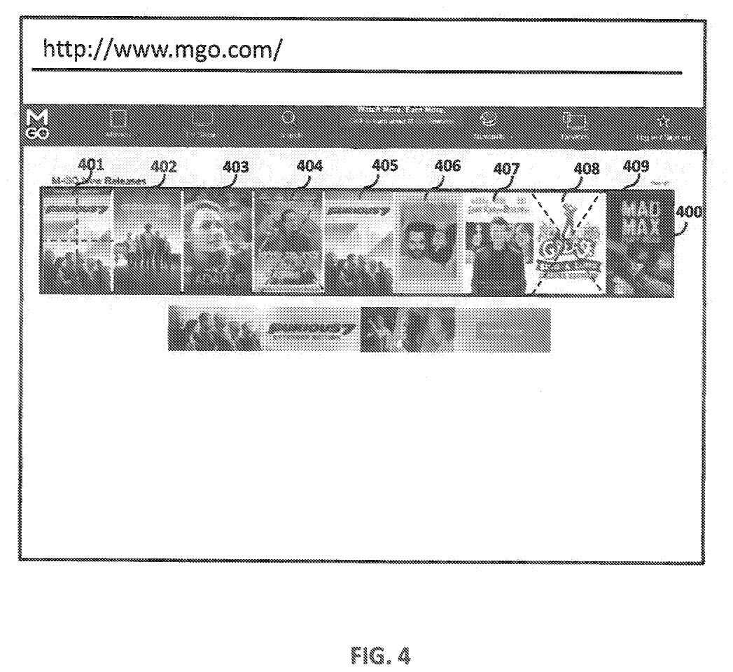

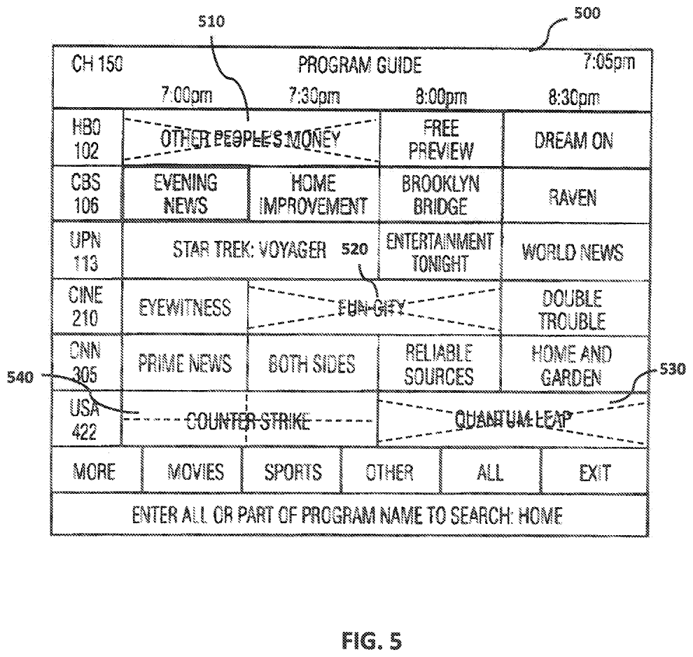

Hence, according to the present principles, FIG. 4 shows an exemplary electronic program listing 400 which has a plurality of graphical representations with e.g., different resolutions, degree of sharpness, and/or blurriness representing different programs having different content with different video resolutions. For example, graphical representations 404 and 408 (with dashed X's) represent programs in UHD format. Graphical representation 401 (with a dashed cross) represents program in HD format. The other programs 402-403, 405-407, and 409 on the program listing 400 are in SD format. Likewise, FIG. 5 shows three programs 510, 520 and 530 (with dashed X's) in UHD format, and one program 540 (with a dashed cross) in HD format and the rest of the programs in SD format in a program listing of an electronic grid guide 500 according to the present principles.

Numerous specific details have been set forth herein to provide a thorough understanding of the present principles. It will be understood by those skilled in the art, however, that the examples above may be practiced without these specific details. In other instances, well-known operations, components and circuits have not been described in detail so as not to obscure the present principles. It can be appreciated that the specific structural and functional details disclosed herein may be representative and do not necessarily limit the scope of the present principles.

Various examples of the present principles may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

1. A method performed by an apparatus, comprising:
receiving, via a communication interface, metadata associated with a program of video data, said metadata indicating a corresponding video resolution format of content of said program; and
providing an electronic program listing to a video display, wherein said electronic program listing comprising a plurality of graphical representations representing different programs including said program of said video data, and a resolution of a graphical representation corresponding to said program of said video data is selected in response to said corresponding video resolution format of said content of said program indicated in said received metadata.

2. The method of claim 1 wherein said resolution of said graphical representation corresponding to said program of said video data is selected in further response to a resolution of said video display.

3. The method of claim 2 wherein said resolution of said video display is one of standard definition (SD), high definition (HD), and ultra high definition (UHD).

4. The method of claim 1 wherein said corresponding video resolution format is one of standard definition (SD), high definition (HD), and ultra high definition (UHD).

5. The method of claim 4, wherein said graphical representation corresponding to said program of said video data uses one of (1) a first pixel size for said metadata indicating that said corresponding video resolution format of said content of said program is a standard definition (SD) format, (2) a second pixel size for said metadata indicating that said corresponding video resolution format of said content of said program is a high definition (HD) format, and (3) a third pixel size for said metadata indicating that said corresponding video resolution format of said content of said program is an ultra high (UHD) definition format.

6. The method of claim 5, wherein said first pixel size is larger than said second pixel size.

7. The method of claim 6, wherein said second pixel size is larger than said third pixel size.

8. The method of claim 1 wherein said resolution of said graphical representation corresponding to said program of said video data is selected such that a higher resolution of said graphical representation is selected in correlation with said corresponding video resolution format of said content of said program indicated in said received metadata as being higher.

9. The method of claim 8 wherein said higher resolution of said graphical representation is provided by increased pixel count of said graphical representation.

10. The method of claim 1 wherein said resolution of said graphical representation corresponding to said program of said video data is selected such that a lower resolution of said graphical representation is selected in correlation with said corresponding video resolution format of said content of said program indicated in said received metadata as being lower.

11. The method of claim 10 wherein said lower resolution of said graphical representation is provided by increased size of pixels of said graphical representation.

12. The method of claim 1 further comprising accessing from a database said plurality of graphical representations representing said different programs, each one of said plurality of graphical representations having one or more corresponding versions, and each one of said versions having a respective resolution.

13. The method of claim 12 wherein said respective resolution has a respective number of pixels, with a higher number of pixels being a higher resolution.

14. The method of claim 1 wherein said electronic program listing is an electronic program grid guide.

15. The method of claim 1 wherein each one of said plurality of graphical representations comprising one or more of (1) an image representing a corresponding program and (2) texts representing a corresponding program.

16. A method performed by an apparatus, comprising:
receiving, via a communication interface, metadata associated with a program of video data, said metadata indicating a corresponding video resolution format of content of said program; and
providing an electronic program listing to a video display, wherein said electronic program listing comprising a plurality of graphical representations representing different programs including said program of said video data, and a degree of sharpening of a graphical representation corresponding to said program of said video data is selected in response to said corresponding video resolution format of said content of said program indicated in said received metadata.

17. An apparatus, comprising:
a communication interface configured to receive metadata associated with a program of video data, said metadata indicating a corresponding video resolution format of content of said program; and
a processor configured to provide an electronic program listing to a video display, wherein said electronic program listing comprising a plurality of graphical representations representing different programs including said program of said video data, and a resolution of a graphical representation corresponding to said program of said video data is selected in response to said corresponding video resolution format of said content of said program indicated in said received metadata.

18. The apparatus of claim 17 wherein said resolution of said graphical representation corresponding to said program of said video data is selected in further response to a resolution of said video display.

19. The apparatus of claim 18 wherein said resolution of said video display is one of standard definition (SD), high definition (HD), and ultra high definition (UHD).

20. The apparatus of claim 17 wherein said corresponding video resolution format is one of standard definition (SD), high definition (HD), and ultra high definition (UHD).

21. The apparatus of claim 20, wherein said graphical representation corresponding to said program of said video data uses one of (1) a first pixel size for said metadata indicating that said corresponding video resolution format of said content of said program is a standard (SD) format, (2) a second pixel size for said metadata indicating that said corresponding video resolution format of said content of said program is a high definition (HD) format, and (3) a third pixel size for said metadata indicating that said corresponding video resolution format of said content of said program is an ultra high definition (UHD) format.

22. The apparatus of claim 21, wherein said first pixel size is larger than said second pixel size.

23. The apparatus of claim 22, wherein said second pixel size is larger than said third pixel size.

24. The apparatus of claim 17 wherein said resolution of said graphical representation corresponding to said program of said video data is selected such that a higher resolution of said graphical representation is selected in correlation with said corresponding video resolution format of said content of said program indicated in said received metadata as being higher.

25. The apparatus of claim 24 wherein said higher resolution of said graphical representation is provided by increased pixel count of said graphical representation.

26. The apparatus of claim 17 wherein said resolution of said graphical representation corresponding to said program of said video data is selected such that a lower resolution of said graphical representation is selected in correlation with said corresponding video resolution format of said content of said program indicated in said received metadata as being lower.

27. The apparatus of claim 26 wherein said lower resolution of said graphical representation is provided by increased size of pixels of said graphical representation.

28. The apparatus of claim 17 further comprising accessing from a database said plurality of graphical representations representing said different programs, each of said plurality of graphical representations having one or more corresponding versions, and each of said versions having a respective resolution.

29. The apparatus of claim 28 wherein said respective resolution has a respective number of pixels, with a higher number of pixels being a higher resolution.

30. The apparatus of claim 17 wherein said electronic program listing is an electronic program grid guide.

31. The apparatus of claim 17 wherein each of said plurality of graphical representations comprising one or more of (1) an image representing a corresponding program and (2) texts representing a corresponding program.

32. An apparatus, comprising:
a communication interface configured to receive metadata associated with a program of video data, said metadata indicating a corresponding video resolution format of content of said program; and
a processor configured to provide an electronic program listing to a video display, wherein said electronic program listing comprising a plurality of graphical representations representing different programs including said program of said video data, and a degree of sharpening of a graphical representation corresponding to said program of said video data is selected in response to said corresponding video resolution format of said content of said program indicated in said received metadata.

33. A computer program product stored in non-transitory computer-readable storage media, comprising computer-executable instructions for:
receiving metadata associated with a program of video data, said metadata indicating a corresponding video resolution format of content of said program; and
providing an electronic program listing to a video display, wherein said electronic program listing comprising a plurality of graphical representations representing different programs including said program of said video data, and a resolution of a graphical representation corresponding to said program of said video data is selected in response to said corresponding video resolution format of said content of said program indicated in said received metadata.
